(19) United States
(12) Patent Application Publication
(10) Pub. No.: US 2025/0384086 A1
(43) Pub. Date: Dec. 18, 2025

(54) FEDERATED LOUVAIN ALGORITHM BASED ON SECRET SHARING TECHNOLOGY

(71) Applicant: Beijing Zitiao Network Technology Co., Ltd., Beijing (CN)

(72) Inventors: Xing Wu, Beijing (CN); Chuyuan Chen, Beijing (CN); Li Wang, Beijing (CN); Qiang Yan, Beijing (CN)

(21) Appl. No.: 19/236,686

(22) Filed: Jun. 12, 2025

Related U.S. Application Data
(63) Continuation of application No. PCT/CN2024/099169, filed on Jun. 14, 2024.

(51) Int. Cl. G06F 16/901; H04L 9/08

(52) U.S. Cl. CPC G06F 16/9024; H04L 9/085

(57) ABSTRACT

A computer-implemented method includes accessing, by one of more devices of a first region, an input graph comprising a plurality of nodes and a plurality of edges, each edge connecting two nodes from the plurality of nodes, where each node represents one or more users from the first region. For each node and using a secret sharing protocol: 1) one or more modularity gains for moving the node from an original community into one or more respective candidate communities is calculated and 2) an identified direction for moving the node based on the one or more modularity gains is calculated. The input graph is partitioned into a plurality of communities based on moving each node in the respective identified direction. If a determination is made that a threshold condition has been satisfied, an output graph is generated for the plurality of communities.

CROSS-REFERENCE TO RELATED APPLICATION(S)

This application claims priority to International Patent Application PCT/CN2024/099169 filed Jun. 14, 2024, the disclosure of which is incorporated herein by reference in its entirety.

### TECHNICAL FIELD

This specification generally relates to community detection on online platforms.

### BACKGROUND

Online platforms such as a content sharing platform can connect its users from multiple regions, which may give rise to risk control scenarios where a user-user edge graph can be constructed for subsequent tasks related to risk control based on this graph. Examples of risk control scenarios can include detecting specific on-line communities engaging in malicious activities. In this context, community detection algorithms can play a pivotal role in graph computing algorithms for business risk control scenarios.

### SUMMARY

In one aspect, some implementations provide a computer-implemented method including: accessing, by one of more devices of a first region, data encoding an input graph comprising a plurality of nodes and a plurality of edges, each edge connecting two nodes from the plurality of nodes, wherein each node represents one or more users from the first region on an online platform; calculating, for each node and using a secret sharing protocol in conjunction with one or more devices of a second region, one or more modularity gains for moving the node from an original community into one or more respective candidate communities; generating, for each node and using the secret sharing protocol in conjunction with the one or more devices of the second region, an identified direction for moving the node based on the one or more modularity gains; partitioning the input graph into a plurality of communities based on moving each node in the respective identified direction; determining a threshold condition has been satisfied; and in response to determining the threshold condition has been satisfied, generating an output graph for the plurality of communities.

The implementations may include one or more of the following features.

The identified direction for moving each node may be associated with a maximal modularity gain among the one or more modularity gains. Moving each node in the identified direction may result in a positive modularity gain. The modularity gain may quantify a density of connections within a community. The computer-implemented method may further include: in response to determining that the threshold condition has not been satisfied, launching a new iteration for partitioning the input graph by moving each node in the input graph based on newly calculated modularity gains using the secret sharing protocol in conjunction with the one or more devices of the second region. The threshold condition may include one of: a maximum number of iterations, or whether the nodes of the input graph have not been updated for a pre-determined duration of time. The computer-implemented method may further include at least one of: comprising at least one of: merging two or more cross-regional nodes into a meta node of a cross-regional community; and merging two or more cross-regional edges into a metal edge for the cross-regional community.

In another aspect, some implementations provide one or more computer-readable storage media encoded with instructions that, when executed by one or more computers from a first region, cause the one or more computers to perform operations comprising: accessing data encoding an input graph comprising a plurality of nodes and a plurality of edges, each edge connecting two nodes from the plurality of nodes, wherein each node represents one or more users from the first region on an online platform; calculating, for each node and using a secret sharing protocol in conjunction with one or more devices of a second region, one or more modularity gains for moving the node from an original community into one or more respective candidate communities; generating, for each node and using the secret sharing protocol with the one or more devices of the second region, an identified direction for moving the node based on the one or more modularity gains; partitioning the input graph into a plurality of communities based on moving each node in the respective identified direction; determining a threshold condition has been satisfied; and in response to determining the threshold condition has been satisfied, generating an output graph for the plurality of communities.

The implementations may provide one or more of the following features.

The identified direction for moving each node may be associated with a maximal modularity gain among the one or more modularity gains. Moving each node in the identified direction may result in a positive modularity gain. The modularity gain may quantify a density of connections within a community. The operations may further include: in response to determining that the threshold condition has not been satisfied, launching a new iteration for partitioning the input graph by moving each node in the input graph based on newly calculated modularity gains using the secret sharing protocol in conjunction with the one or more devices of the second region. The threshold condition may include one of: a maximum number of iterations, or whether the nodes of the input graph have not been updated for a pre-determined duration of time. The operations may further include at least one of: comprising at least one of: merging two or more cross-regional nodes into a meta node of a cross-regional community; and merging two or more cross-regional edges into a metal edge for the cross-regional community.

In yet another aspect, some implementations provide a computer system comprising one or more computer processors located in a first region and configured to perform operations comprising: accessing data encoding an input graph comprising a plurality of nodes and a plurality of edges, each edge connecting two nodes from the plurality of nodes, wherein each node represents one or more users from the first region on an online platform; calculating, for each node and using a secret sharing protocol in conjunction with one or more devices of a second region, one or more modularity gains for moving the node from an original community into one or more respective candidate communities; generating, for each node and using the secret sharing protocol with the one or more devices of the second region, an identified direction for moving the node based on the one or more modularity gains; partitioning the input graph into a plurality of communities based on moving each node in the respective identified direction; determining a threshold condition has been satisfied; and in response to determining the threshold condition has been satisfied, generating an output graph for the plurality of communities.

The subject matter described in this specification can be implemented in particular embodiments so as to realize one or more of the following advantages. First, some implementations employ technical solutions unique to computerized communication networks to construct graphs for community detection securely and without revealing internal information to computing devices outside the region. For example, the implementations incorporate a federated Louvain algorithm to solve the problem of community detection in a cross-regional environment. The implementations thus incorporate a distributed environment for the Louvain algorithm. In this distributed environment, the implementations then use secret sharing techniques to access variables with data portions split among different regions and conduct computations in a secure manner to protect the data that needs to be transmitted in a distributed environment. The implementations also incorporate iterative graph construction for community detection in the distributed environment with each region operating in the federated manner.

Second, the implementations are scalable to operate on large-scale online platforms that are dynamic in nature when users can join or leave and as connections are made or dissolved. Indeed, the implementations can operate in real-time for large numbers (e.g., hundreds of millions, billions, or more) of registered users. The sheer volume and speed render the computational tasks infeasible for the human mind. Moreover, the ability to process graph construction in real-time allows practical applications never before feasible on large networks including, for example, including finding malicious groups in risk control scenarios, finding groups who have the same purchasing interests in e-commerce scenario, finding potential relationships on social networks by identifying contacts based on the contacts' community, providing content personalization to deliver relevant content to users based on the users' community, or spam/fraud detection by identifying anomalies in community structures.

The details of one or more implementations of the subject matter of this specification are set forth in the description, the claims, and the accompanying drawings. Other features, aspects, and advantages of the subject matter will become apparent from the description, the claims, and the accompanying drawings.

### BRIEF DESCRIPTION OF DRAWINGS

FIG. 1 illustrates an example of a cross-regional graph between two regions subject to data privacy constraints.

FIG. 2 illustrates an example of a workflow diagram to identify cross-regional communities.

FIG. 3 illustrates an example for constructing a cross-regional graph.

FIG. 4 is a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The disclosed technology addresses the technical challenge of constructing a user-user graph in a cross-regional environment where inter-regional data sharing is rather limited (e.g., constrained by the privacy requirements of each region). For example, privacy rules may prohibit computing servers of a region from revealing intra-region information of active users in the region to computing devices of other regions. The region may refer to a geographic region, or virtual region defined by virtual private network (VPN) rules. Further, the computing servers of each region may not reveal information specific to user activity to computing devices of other regions. Because computing servers of different regions may not exchange cross-regional data directly, constructing a user-user graph in the cross-regional environment can be challenging.

The disclosed technology includes the following salient features as part of a solution to the technical challenge. These salient features improve the operation of the underlying computing and communication infrastructure. First, many implementations incorporate a federated Louvain algorithm to solve the challenge of community detection in a cross-regional environment where data exchanges between the regions can be restricted. The solution is a distributed implementation of the Louvain algorithm where the computing servers of each region may operate on graphs of each respective region with cross-regional visibility limited to nodes and edges that directly border with the region. Changes to the cross-regional nodes and edges can trigger corresponding revision of the graph for the region.

Second, many implementations incorporate a secret sharing technology as a cryptographic method to enhance the security of online communications by dividing a secret into multiple parts. Each part is then distributed to one of the regions involved, and the original secret can only be reconstructed when a sufficient number of these parts are combined. Secret sharing can be particularly useful in scenarios where sensitive information is split between multiple regions, and the reconstruction process does not reveal shares known by other regions.

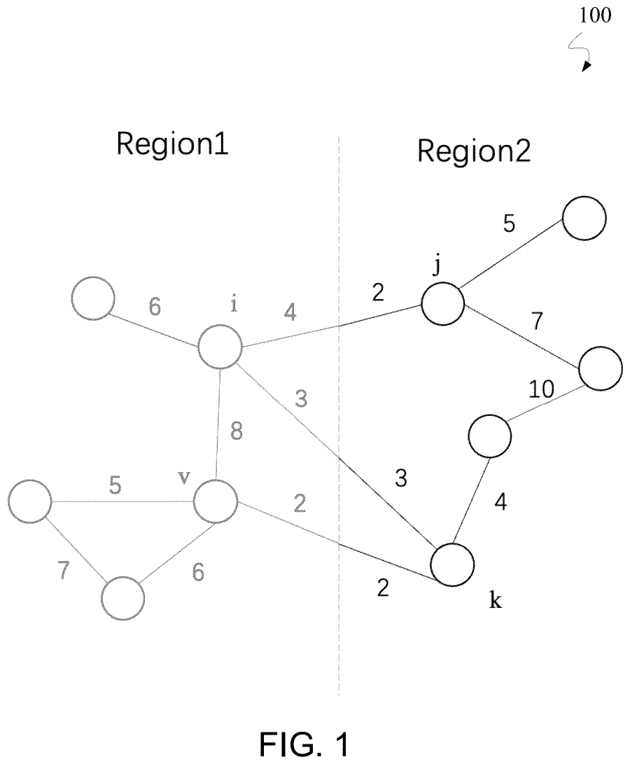

The disclosed technology thus addresses the technical challenge of protecting data privacy that is unique to a modern platform digitally interconnecting a vast number of registered users. Examples can range from hundreds of thousands to billions of active users as recorded on modern online platforms including mobile network, content-sharing site, e-commerce site, or social network site. More details of these salient features are provided below with references to FIGS. 1 through 4.

FIG. 1 illustrates an example of a cross-regional graph between two regions subject to data privacy constraints. The nodes and edges under region 1 (i.e., on the left of the dashed line) are only visible to region 1 while the nodes and edges under region 2 (i.e., on the right of the dashed line) are the parts visible only to region 2. Each node may represent a user (e.g., an active user on the online platform). Alternatively or additionally, each node may represent a community of users (e.g., a community in the process of being identified, which includes more than one user). Each edge may refer to a form of signal between users. In the context of graph construction and community detection, a signal can represent characteristics related to the scene of each participating user on the online platform. For example, in a social networking software scene, signals may refer to features such as device name/identification, internet protocol (IP) address, or universal resource locator (URL) address as used by each participating user.

As explained above, each region (either a geographical region or a virtual region) may have its own data privacy regulations that prohibit region-specific information to be disseminated outside, thereby giving rise to restricted visibility of other regions' data. Here, the numbers on the edges represent the weights of the edges. The weights of some edges (e.g., cross-regional edges) are shared by nodes from both regions. For example, for edge eᵢⱼ, region 1 stores a weight value of 4, while region 2 stores a weight value of 2. This storage method where each region only knows a part of the total value can be implemented as a secret sharing storage method. While it is impossible to perceive the information of a complete picture for all the regions, in some regions it may also be illegal to directly expose unique local intra-region information to entities outside the region. The implementations of the present disclosure are directed to a federated Louvain method in which graph information and training can be communicated in a safe and secure manner using secret sharing techniques.

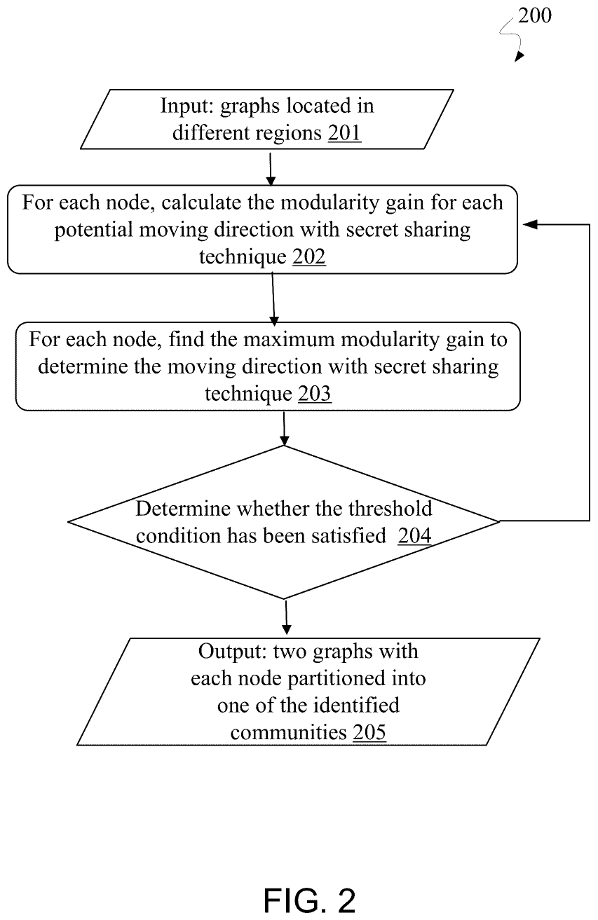

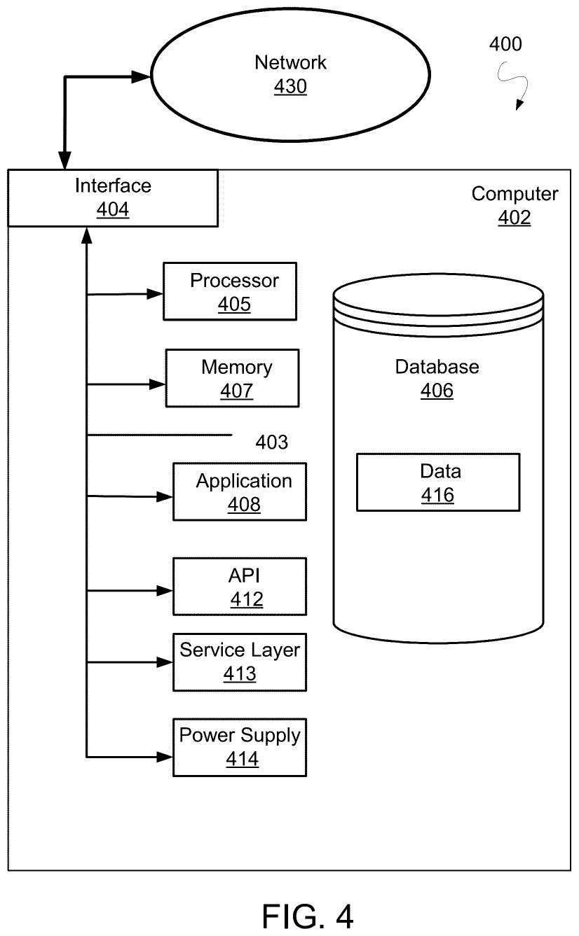

FIG. 2 illustrates an example of process 200 to identify cross-regional communities. For convenience, the process 200 will be described as being performed by a system of one or more computers, located in one or more locations, and programmed appropriately in accordance with this specification. For example, the system can include a server computer, e.g., the server computer FIG. 4, that when appropriately programmed, can perform the process 100. The system can incorporate a server computer for one of the multiple regions for which the cross-regional security graph is being constructed.

The input 201 includes two graphs located at two corresponding regions. An identifier is associated with each user node. The system can import the graph for the region where the system resides. For example, the system operating at region 1 can import the graph for region 1. Likewise, the system operating at region 2 can import the graph for region 2. Due to data privacy constraints, the system operating at region 1 would not have direct visibility of the graph for region 2, and the system operating at region 2 would not have access to inspect the graph for region 1. In each graph, each node can indicate a user node, which can correspond to an active user on the platform. Each node may also represent multiple original user nodes coalesced as one community node. The edges between nodes represent connections between users. Examples of connections include signals in the context of graph construction and community detection.

In step 202, the system calculates, for each node, the modularity gain for each potential moving direction with secret sharing techniques. Modularity is a measure used to quantify the quality of a partitioning of a network of nodes into communities. By moving a node from one community to another community, the quality of network partitioning is changed, which can be quantified to determine the optimal moving direction. A high modularity score indicates a strong community structure, where there are dense connections between the nodes within communities but sparse connections between nodes in different communities. The modularity gain, known as ΔQ, can form the basis for determining the best moving direction of each node because the metric quantifies the benefits of moving the node to different neighboring communities. Considering the process of node u moving from the original community Cᵤ to the new community Cᵥ where neighbor node v is located, the calculation for ΔQ can be expressed as:

$$Δ Q = {kv}_{in 1} - {kv}_{in 2} + \frac{kv * tot 2 - {kv}^{2} - kv * tot 1}{2 m} \qquad ( 1 )$$

where kvᵢₙ₁ represents the sum of weights of the edges from node u to community Cᵥ; kvᵢₙ₂ represents the sum of weights of the edges from node u to community Cᵤ; kv represents the degree of node u; tot1 represents the degree of community Cᵥ; tot2 represents the degree of community Cᵤ; m represents the sum of weights of the entire graph. Here, the degree of a node is a measure of the number of connections or edges that the node has to other nodes. The degree of a community can refer to the sum of the degrees of its constituent nodes with respect to the edges that connect these nodes to nodes outside the community.

Under the security model that drives the implementations of the present disclosure, the variables required to calculate ΔQ are split in parts which are stored in different regions. A distributed rewriting of Equation (1) of ΔQ can be expressed as:

$$Δ Q = {\vert {kv}_{in 1} \vert}_{r 1} + {\vert {kv}_{in 1} \vert}_{r 2} - ( {\vert {kv}_{in 2} \vert}_{r 1} + {\vert {kv}_{in 2} \vert}_{r 2} ) + \frac{\begin{matrix}( {\vert kv \vert}_{r 1} + {\vert kv \vert}_{r 2} ) * ( {\vert tot 2 \vert}_{r 1} + {\vert tot 2 \vert}_{r 1} ) - \\ {( {kv}_{r 1} + {kv}_{r 2} )}^{2} - ( {\vert kv \vert}_{r 1} + {\vert kv \vert}_{r 2} ) * ( {\vert tot 1 \vert}_{r 1} + {\vert tot 1 \vert}_{r 2} )\end{matrix}}{2 ( \vert {m}_{r 1} \vert + \vert {m}_{r 2} \vert )} \qquad ( 2 )$$

where “*ᵣ₁” indicates the portion of data that exists on the server computer for region 1, “*ᵣ₂” indicates the portion of data that exists on the server computer for region 2. Because the implementations of the present disclosure operate on data with portions split between different server computers at different regions that may not communicate the information with each other, the new distributed computing equation (2) will replace the equation (1).

Significantly, “*ᵣ₁” and “*ᵣ₂” refer to data portions of the same variable “*” that remain invisible to the server computer from a different region under the security model incorporated by the implementations of the present disclosure. In fact, these data portions are regarded as sub-secrets of variable “*” Exemplary implementations of the present disclosure incorporate secret sharing techniques to perform the calculation involving variables whose data portions are split between server computers from different regions. The calculation result is also in the form of secret sharing so that the secret sharing of ΔQ can be obtained.

By way of context, secret sharing can refer to the state of the existence of a value. For example, for a value of 8, region 1 records a portion of 3 and region 2 records a portion of 5. The fact is that the value is 8, but region 1 and region 2, due to the lack of information about the other side, do not know the exact result. In this example, the secret (an actual value) is split into several pieces, known as shares, using a mathematical algorithm. One of the most common algorithms for this purpose is Shamir's secret sharing scheme based on polynomial interpolation. When the shares are distributed to different parties, each party holds only a portion of the secret, and no individual share reveals any information about the original secret. During reconstruction, using these shares, the polynomial can be reconstructed through interpolation, and the secret (the constant term) can be recovered. Secret sharing can include a series of algorithms to achieve computation based on variables whose data portions split between server computers of different regions while protecting each respective portion.

In step 203, the system finds, for each node, the maximum modularity gain to decide the moving direction with secret sharing techniques. Specifically, each node u may have more than one neighboring node v, which corresponds to multiple moving directions. In step 203, the system can calculate ΔQ for each moving direction separately, and then also use secret sharing techniques to determine the maximum ΔQ among these directions. If this value is larger than 0, the community direction corresponding to this ΔQ can be the direction that node u is moving towards. For example, in some implementations, the system can keep a counter to retain the configuration of the presently identified optimal direction until a new direction is found that yields a positive gain of ΔQ over the presently identified optimal direction.

In step 204, the system determines whether a threshold condition is reached. Examples of threshold conditions include: a maximum number of iteration training rounds, whether nodes are still updating, or whether no additional gains of the modularity metric can be achieved. If the threshold condition is not satisfied, the system may start another iteration by recalculating the modularity gain at step 202. If the threshold condition is satisfied, in step 205, the system generates an output graph for the region it operates in.

After the system completes the first phase, as explained above, the system may proceed to merge nodes and edges resulting from the first phase. For example, during the second phase, the system may merge nodes partitioned into a community into a meta node, merge the connected edges between the communities into meta connected edges, and merge the connected edges within the community into self-connected edges. These connections may also exist in the form of secret sharing.

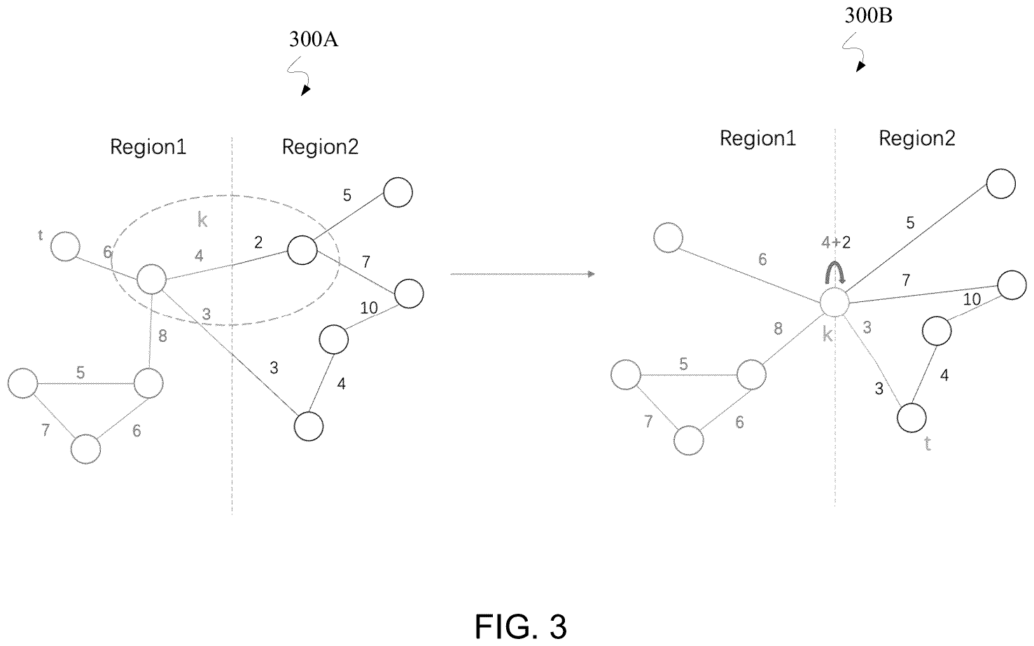

FIG. 3 illustrates an example for constructing a cross-regional graph. In this example, community k in subpanel 300A is merged into a meta node k, as shown in right subpanel 300B. This merge consolidates two neighboring nodes from region 1 and region 2. In the right subpanel 300B, edge eₖₜ still exists in the form of secret sharing. This newly merged graph can be used as the input for the next round of iterative training (e.g., input to step 202 of FIG. 2). In some implementations, the above stages can be repeated until the graph converges or settles so that no additional update can be identified. In exemplary scenarios involving two regions, namely, region1 and region2, the system for each region can respectively obtain the final community number corresponding to each local node. The community number is shared globally. When a node on both sides has the same community number, the node can be considered to form a cross-regional community. The implementations can identify such cross-regional communities.

The implementations can be used in many community detection tasks including, for example, finding malicious groups in risk control scenarios, finding groups who have the same purchasing interests in e-commerce scenarios, and finding potential relationships on social networks. However, no global graph may be obtained, and the system of each region can only construct discrete subgraphs for each respective region. As such, directly using the native Louvain algorithm is technically infeasible. In such scenarios (e.g., restricted data sharing on privacy grounds), the implementations of the present disclosure can be helpful by incorporating a federated Louvain algorithm. There are many scenarios where no global graph may be obtained. In some cases, a company's users are located in different countries where the country-specific data may not be directly joined. In some cases, two companies may desire to cooperate in a community detection task and their respective internal data may not be directly joined.

FIG. 4 is a block diagram illustrating an example of a computer system 400 used to provide computational functionalities associated with described algorithms, methods, functions, processes, flows, and procedures, according to an implementation of the present disclosure. The illustrated computer 402 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 402 can comprise a computer that includes an input device, such as a keypad, keyboard, touch screen, another input device, or a combination of input devices that can accept user information, and an output device that conveys information associated with the operation of the computer 402, including digital data, visual, audio, another type of information, or a combination of types of information, on a graphical-type user interface (UI) (or GUI) or other UI.

The computer 402 can serve in a role in a computer system as a client, network component, a server, a database or another persistency, another role, or a combination of roles for performing the subject matter described in the present disclosure. The illustrated computer 402 is communicably coupled with a network 430. In some implementations, one or more components of the computer 402 can be configured to operate within an environment, including cloud-computing-based, local, global, another environment, or a combination of environments.

The computer 402 is an electronic computing device operable to receive, transmit, process, store, or manage data and information associated with the described subject matter. According to some implementations, the computer 402 can also include or be communicably coupled with a server, including an application server, e-mail server, web server, caching server, streaming data server, another server, or a combination of servers.

The computer 402 can receive requests over network 430 (for example, from a client software application executing on another computer 402) and respond to the received requests by processing the received requests using a software application or a combination of software applications. In addition, requests can also be sent to the computer 402 from internal users, external or third-parties, or other entities, individuals, systems, or computers.

Each of the components of the computer 402 can communicate using a system bus 403. In some implementations, any or all of the components of the computer 402, including hardware, software, or a combination of hardware and software, can interface over the system bus 403 using an application programming interface (API) 412, a service layer 413, or a combination of the API 412 and service layer 413. The API 412 can include specifications for routines, data structures, and object classes. The API 412 can be either computer-language independent or dependent and refer to a complete interface, a single function, or even a set of APIs. The service layer 413 provides software services to the computer 402 or other components (whether illustrated or not) that are communicably coupled to the computer 402. The functionality of the computer 402 can be accessible for all service consumers using this service layer. Software services, such as those provided by the service layer 413, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 402, alternative implementations can illustrate the API 412 or the service layer 413 as stand-alone components in relation to other components of the computer 402 or other components (whether illustrated or not) that are communicably coupled to the computer 402. Moreover, any or all parts of the API 412 or the service layer 413 can be implemented as a child or a sub-module of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402. The interface 404 is used by the computer 402 for communicating with another computing system (whether illustrated or not) that is communicatively linked to the network 430 in a distributed environment. Generally, the interface 404 is operable to communicate with the network 430 and comprises logic encoded in software, hardware, or a combination of software and hardware. More specifically, the interface 404 can comprise software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors can be used according to particular needs, desires, or particular implementations of the computer 402. Generally, the processor 405 executes instructions and manipulates data to perform the operations of the computer 402 and any algorithms, methods, functions, processes, flows, and procedures as described in the present disclosure.

The computer 402 also includes a database 406 that can hold data for the computer 402, another component communicatively linked to the network 430 (whether illustrated or not), or a combination of the computer 402 and another component. For example, database 406 can be an in-memory, conventional, or another type of database storing data consistent with the present disclosure. In some implementations, database 406 can be a combination of two or more different database types (for example, a hybrid in-memory and conventional database) according to particular needs, desires, or particular implementations of the computer 402 and the described functionality. Although illustrated as a single database 406 in FIG. 4, two or more databases of similar or differing types can be used according to particular needs, desires, or particular implementations of the computer 402 and the described functionality. While database 406 is illustrated as an integral component of the computer 402, in alternative implementations, database 406 can be external to the computer 402. As illustrated, the database 406 holds the previously described data 416 including, for example, data encoding the graphs comprising nodes and edges.

The computer 402 also includes a memory 407 that can hold data for the computer 402, another component or components communicatively linked to the network 430 (whether illustrated or not), or a combination of the computer 402 and another component. Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 or similar or differing types can be used according to particular needs, desires, or particular implementations of the computer 402 and the described functionality. While memory 407 is illustrated as an integral component of the computer 402, in alternative implementations, memory 407 can be external to the computer 402.

The application 408 is an algorithmic software engine providing functionality according to particular needs, desires, or particular implementations of the computer 402, particularly with respect to functionality described in the present disclosure. For example, application 408 can serve as one or more components, modules, or applications. Further, although illustrated as a single application 408, the application 408 can be implemented as multiple applications 408 on the computer 402. In addition, although illustrated as integral to the computer 402, in alternative implementations, the application 408 can be external to the computer 402.

The computer 402 can also include a power supply 414. The power supply 414 can include a rechargeable or non-rechargeable battery that can be configured to be either user-or non-user-replaceable. In some implementations, the power supply 414 can include power-conversion or management circuits (including recharging, standby, or another power management functionality). In some implementations, the power-supply 414 can include a power plug to allow the computer 402 to be plugged into a wall socket or another power source to, for example, power the computer 402 or recharge a rechargeable battery.

There can be any number of computers 402 associated with, or external to, a computer system containing computer 402, each computer 402 communicating over network 430. Further, the term “client,” “user,” or other appropriate terminology can be used interchangeably, as appropriate, without departing from the scope of the present disclosure. Moreover, the present disclosure contemplates that many users can use one computer 402, or that one user can use multiple computers 402.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory devices. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/-R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method comprising:
accessing, by one of more devices of a first region, data encoding an input graph comprising a plurality of nodes and a plurality of edges, each edge connecting two nodes from the plurality of nodes, wherein each node represents one or more users from the first region on an online platform;
calculating, for each node and using a secret sharing protocol in conjunction with one or more devices of a second region, one or more modularity gains for moving the node from an original community into one or more respective candidate communities;
generating, for each node and using the secret sharing protocol in conjunction with the one or more devices of the second region, an identified direction for moving the node based on the one or more modularity gains;
partitioning the input graph into a plurality of communities based on moving each node in the respective identified direction;
determining a threshold condition has been satisfied; and
in response to determining the threshold condition has been satisfied, generating an output graph for the plurality of communities.

2. The computer-implemented method of claim 1, wherein the identified direction for moving each node is associated with a maximal modularity gain among the one or more modularity gains.

3. The computer-implemented method of claim 1, wherein moving each node in the identified direction results in a positive modularity gain.

4. The computer-implemented method of claim 1, wherein a modularity gain quantifies a density of connections within a community.

5. The computer-implemented method of claim 1, further comprising:
in response to determining that the threshold condition has not been satisfied, launching a new iteration for partitioning the input graph by moving each node in the input graph based on newly calculated modularity gains using the secret sharing protocol in conjunction with the one or more devices of the second region.

6. The computer-implemented method of claim 1, wherein the threshold condition comprises one of: a maximum number of iterations, or whether the nodes of the input graph have not been updated for a pre-determined duration of time.

7. The computer-implemented method of claim 1, further comprising at least one of:
merging two or more cross-regional nodes into a meta node of a cross-regional community; and
merging two or more cross-regional edges into a metal edge for the cross-regional community.

8. One or more computer-readable storage media encoded with instructions that, when executed by one or more computers from a first region, cause the one or more computers to perform operations comprising:
accessing data encoding an input graph comprising a plurality of nodes and a plurality of edges, each edge connecting two nodes from the plurality of nodes, wherein each node represents one or more users from the first region on an online platform;
calculating, for each node and using a secret sharing protocol in conjunction with one or more devices of a second region, one or more modularity gains for moving the node from an original community into one or more respective candidate communities;
generating, for each node and using the secret sharing protocol with the one or more devices of the second region, an identified direction for moving the node based on the one or more modularity gains;
partitioning the input graph into a plurality of communities based on moving each node in the respective identified direction;
determining a threshold condition has been satisfied; and
in response to determining the threshold condition has been satisfied, generating an output graph for the plurality of communities.

9. The one or more computer-readable storage media of claim 8, wherein the identified direction for moving each node is associated with a maximal modularity gain from among the one or more modularity gains.

10. The one or more computer-readable storage media of claim 8, wherein the identified direction for moving each node results in a positive modularity gain.

11. The one or more computer-readable storage media of claim 8, wherein a modularity gain quantifies a density of connections within a community.

12. The one or more computer-readable storage media of claim 8, further comprising:
in response to determining that the threshold condition has not been satisfied, launching a new iteration for partitioning the input graph by moving each node in the input graph based on newly calculated modularity gains using the secret sharing protocol in conjunction with the one or more devices of the second region.

13. The one or more computer-readable storage media of claim 8, wherein the threshold condition comprises one of: a maximum number of iterations, or whether the nodes of the input graph have not been updated for a pre-determined duration of time.

14. The one or more computer-readable storage media of claim 8, wherein the operations further comprise at least one of:
merging two or more cross-regional nodes into a meta node of a cross-regional community; and
merging two or more cross-regional edges into a metal edge for the cross-regional community.

15. A computer system comprising one or more computer processors located in a first region and configured to perform operations comprising:
accessing data encoding an input graph comprising a plurality of nodes and a plurality of edges, each edge connecting two nodes from the plurality of nodes, wherein each node represents one or more users from the first region on an online platform;
calculating, for each node and using a secret sharing protocol in conjunction with one or more devices of a second region, one or more modularity gains for moving the node from an original community into one or more respective candidate communities;
generating, for each node and using the secret sharing protocol with the one or more devices of the second region, an identified direction for moving the node based on the one or more modularity gains;
partitioning the input graph into a plurality of communities based on moving each node in the respective identified direction;
determining a threshold condition has been satisfied; and
in response to determining the threshold condition has been satisfied, generating an output graph for the plurality of communities.

16. The computer system of claim 15, wherein the identified direction for moving each node is associated with a maximal modularity gain from among the one or more modularity gains.

17. The computer system of claim 15, wherein the identified direction for moving each node results in a positive modularity gain.

18. The computer system of claim 15, wherein a modularity gain quantifies a density of connections within a community.

19. The computer system of claim 15, wherein the operations further comprise:
in response to determining that the threshold condition has not been satisfied, launching a new iteration for partitioning the input graph by moving each node in the input graph based on newly calculated modularity gains using the secret sharing protocol in conjunction with the one or more devices of the second region.

20. The computer system of claim 15, wherein the threshold condition comprises one of: a maximum number of iterations, or whether the nodes of the input graph have not been updated for a pre-determined duration of time, and
wherein the operations further comprise at least one of:
merging two or more cross-regional nodes into a meta node of a cross-regional community; and
merging two or more cross-regional edges into a metal edge for the cross-regional community.
